(19) United States
(12) Patent Application Publication
(10) Pub. No.: US 2020/0239744 A1
(43) Pub. Date: Jul. 30, 2020

(54) OPTICAL CLEAR ADHESIVE AND MANUFACTURING METHOD THEREOF

(71) Applicant: NAN YA PLASTICS CORPORATION, Taipei (TW)

(72) Inventors: TE-CHAO LIAO, TAIPEI (TW); SEN-HUANG HSU, TAIPEI (TW); CHAO-QUAN WU, TAIPEI (TW)

(21) Appl. No.: 16/662,208

(22) Filed: Oct. 24, 2019

(30) Foreign Application Priority Data
Jan. 30, 2019 (TW) 108103607

(51) Int. Cl. C09J 7/40; C09J 7/38; C09J 7/20

(52) U.S. Cl. CPC C09J 7/401; C09J 7/38; C09J 2467/005; C09J 2205/114; C09J 2483/005; C09J 7/201

(57) ABSTRACT

An optical clear adhesive (OCA) and a manufacturing method thereof are provided. The OCA is a three-layer laminated structure including an OCA transparent film, a high release film coated on a lower surface of the OCA transparent film and a light release film coated on an upper surface of the OCA transparent. The high release film and the light release film contain 0.01 to 3 wt % of UV absorber. After UV light irradiation, the OCA transparent film has a suitable peeling force between the light release film and the high release film.

### CROSS-REFERENCE TO RELATED PATENT APPLICATION

This application claims the benefit of priority to Taiwan Patent Application No. 108103607, filed on Jan. 30, 2019. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an optical clear adhesive (OCA) and a manufacturing method thereof, and more particularly to an OCA with a release film and a manufacturing method thereof. The release film uses a reactive release agent with UV absorber added, and is applied as a release film for UV clear adhesive.

### BACKGROUND OF THE DISCLOSURE

As shown in FIG. 1, an optically clear adhesive (OCA) 10 is used to bond transparent optical components (such as mobile phone touch panels, lenses and related components), and serve as a protective film, especially as a touch panel protective film.

The OCA 10 is required to have high uniformity, light transmission, and high adhesion. The OCA optical clear adhesive 10 is a three-layer structure, including a OCA transparent film 30 and a high release film 20 and a light release film 40 respectively coated on a lower surface and an upper surface thereof of the OCA transparent film 30 light release film. The high release film 20 and the light release film 40 are usually prepared by using polyethylene terephthalate (PET). The specific structure of the OCA optical clear adhesive 10 is made by applying optical acrylic glue or UV optical acrylic glue to the light release film 40, and after drying, the light release film 40 is heated or UV cured into the OCA transparent film 30. The hardened OCA transparent film 30 is sandwiched by bonding another layer of high release film 20 to keep the surface flat before being wound into a roll. In use, high release film 20 and the light release film 40 have good peelability when used, and it should be ensured that no air bubbles are formed in the OCA transparent film 30.

In the process of bonding with an optical component, the light release film 40 on the OCA optical clear adhesive 30 is peeled off, the OCA transparent film 30 is then bonded to the optical component, and then the high release film 20 is peeled off. In order to achieve a good peeling effect of the release film, a silicone resin is coated on the high release film 20 and the light release film 40 for reducing the peeling force. However peeling phenomenon often occurs during the peeling process, that is, when the light release film 40 is peeled off by using an appropriate peeling force, the optical clear adhesive of the OCA transparent film 30 is likely to adhere to the surface of the light release film 40 (hereinafter, this phenomenon is referred to as overflowing or dispensing).

The OCA optical clear adhesive 10 has low protection performance. In particular, when the thickness of the release film is thin, for example, less than 20 μm, the intermediate OCA transparent film 30 is insufficiently protected by the release film, and when the OCA optical clear adhesive 10 is wound, stored, and transported, the OCA transparent film 30 is easily squeezed, deformed, and the yield of the optical clear adhesive product is lowered. In contrast, when the thickness of the release film is thick, for example, more than 100 μm, the intermediate OCA transparent film 30 is easily brought up during the peeling of the release film, so that the appearance of the OCA transparent film 30 is impaired.

The OCA transparent film 30 is made by using optical acrylic glue and has poor venting properties. After the release film is peeled off, when the OCA transparent film 30 is attached to the glass, problems such as easy generation of bubbles result in secondary bonding processing or scrapping of the product, wasting of manpower, and increasing of product cost, which fail to effectively increase productivity.

In order to solve the above issues, Chinese Patent Publication No. CN107974215A discloses a UV type release agent, in which silica, PMMA or zirconia fine particle material is added to produce a release film of OCA, so that the film itself has release properties. The main purpose of adding fine particles is to reduce bubble generation during bonding process.

Chinese Patent Publication No. CN207617247A discloses an ultra-thin graphene sheet on an upper layer of a polyester film, and then applying a release layer, so as to improve the heat resistance of the release film to a temperature of 220 to 250° C. and to prepare a release film of an OCA optical clear adhesive.

The release film of the conventional optical clear adhesive is soft, and is easy to overflow in the industrial production. When being used, the release film pulls the rubber easily, which makes the peeling difficult. At the same time, when the optical clear adhesive is used, the stripping speed of the release film should be adjusted.

### SUMMARY OF THE DISCLOSURE

In response to the above-referenced technical inadequacies, the present disclosure provides a release film of an optical clear adhesive (OCA), which improves the protection performance of the optical clear adhesive, and makes the OCA less susceptible to deformation during winding, storage and transportation process, and the adhesive layer is not easily picked up by the release film during use.

In one aspect, the present disclosure provides a UV type OCA optical clear adhesive including, from a top surface to a lower surface, a light release film, an OCA optical sheet, and a high release film. The OCA optical sheet has a thickness of 25 to 300 μm and a Shore hardness of 20 to 30 HS; the light release film has a thickness of 19 to 100 μm and is selected from a PET release with a release force of 4 to 25 g/2.5 cm. The high release film has a thickness of 50 to 150 μm and is selected from a PET release film having a release force of 10 to 90 g/2.5 cm, and the peeling effect is optimal when a release force ratio of the high release film to the light release film is 2.5 to 3.5; the appearance of the OCA optical sheet after peeling is better when a thickness ratio of the high release film to the light release film is 0.5 to 5, and the appearance of the OCA optical sheet after peeling is optimal, when the thickness ratio is 0.9 to 3.0.

In one aspect, the present disclosure provides a UV type OCA optical clear adhesive. When the release film is peeled off, the angle between the peeling direction of the release film and the OCA optical sheet is generally between 1 and 90 degrees, preferably between 10 and 50 degrees, the appearance of the peeled OCA optical sheet is more aesthetic, and the angle between the peeling direction of the release film and the OCA optical sheet is also better within 20-40 degree. In contrast, the angle between the OCA optical sheet and the glass is generally between 1 and 90 degrees, preferably between 5 and 50 degrees. After bonding, the OCA optical sheet has fewer bubbles and a better appearance, and the angle of the bonding is preferably between 10 and 30 degrees, and the appearance of the OCA optical sheet after bonding is optimal.

In one aspect, the present disclosure provides an OCA optical clear adhesive manufacturing method includes the following steps:

1) preparing a release agent based on a total weight of the release agent;

a. 0.5 to 7 wt % of thermosetting silicone resin is taken;

b. 92.2 to 99.4 wt % solvent is added and stirred evenly;

c. 0.05 to 0.3 wt % of platinum catalyst is further added and stirred for 15 minutes; and

d. 0.05 to 0.5 wt % of UV absorber is added and stirred for 15 minutes to obtain the release agent; wherein the UV absorber is selected from 2-hydroxy-4-methoxybenzophenone or 2,4-dihydroxybenzophenone;

2) coating the release agent on one side or both sides of a polyester film on a continuously running coating machine, and the release agent having a coating thickness of 1 to 25 μm; and

3) after coating the release agent, heating the polyester film at a temperature of 80 to 130° C. for 10 to 30 seconds, and then drying and hardening to obtain a release film.

In the related art, since the thickness of the OCA optical clear adhesive is required to be more than 100 μm, conventionally used optically clear adhesive is insufficient. After UV light irradiation, the peeling force between the optical sheet and the conventional light release film and the high release film increases and may cause peeling failure or increase peeling force that causes a rubber peeling phenomenon. In the UV type OCA optical clear adhesive of the present disclosure, the light release film and the high release film is added with a UV absorber, which can effectively improve the above-mentioned phenomenon.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a sectional view of an optical clear adhesive according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

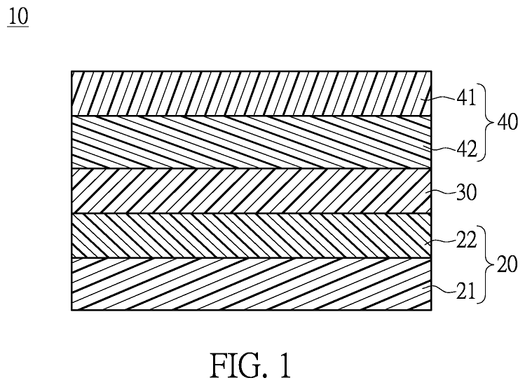

As shown in FIG. 1, the structure of a UV type OCA optical clear adhesive 10 of the present disclosure includes, from a top surface to a lower surface, a light release film 40, an OCA optical sheet 30, and a high release film 20. The OCA optical sheet 30 has a thickness of 25 to 300 μm and a shore hardness of 20 to 30 HS.

The structure of the high release film 20 includes a PET film 21 and a high release silicone resin layer peeling surface 22 (hereinafter referred to as the high release surface layer 22). The structure of the light release film 40 includes a PET film 41 and a light release silicone resin release surface 42 (hereinafter referred to as the light release surface layer 42).

The PET film 21 or 41 is formed by using a single layer or more of a coextruded polyester resin, which is formed by biaxial stretching and heat treatment, and generally has a thickness of 19 to 150 μm, preferably 25 to 100 μm, and more preferably 38 to 75 μm.

The release agent of the present disclosure has a UV absorber formulation and is applied to one or both sides of a continuous-packaged PET film, dried by an oven, hardened, and then wound into a roll-like release film.

In order to achieve a light release force specification, the present disclosure adopts a thermosetting type release agent, and by adding a UV absorber structure, the release layer is more resistant to UV light and weather, and the purpose of light release with an optical clear adhesive is achieved.

The lightr release film 40 of the present disclosure has a thickness of 19 to 150 μm and is selected from a PET release film having a release force of 4 to 25 g/2.5 cm, and a coating thickness of the coated release agent is generally 0.05 to 2 μm, preferably 0.1 to 0.5 μm, and optimal coating thickness is 0.12 to 0.3 μm, which has optimal performance for the peelability of the optical clear adhesive.

In order to achieve a high release force specification, the present disclosure adopts a thermosetting type release agent, and by adding a UV absorber structure, the release layer is more resistant to UV light and weather, and the purpose of high release with an optical clear adhesive is achieved.

The high release film 20 of the present disclosure has a thickness of 50 to 150 μm and is selected from a PET release film having a release force of 10 to 90 g/2.5 cm, and a release force ratio of the high release film 20 to the light release film 40 is 2.5 to 3.5, and the peeling effect is of optimal.

The high release film 20 of the present disclosure has a coating thickness of a coated release agent, generally ranging from 1 to 25 μm, preferably a coating thickness of 2 to 20 μm.

After thermal over-hardening, the thickness of the high release surface layer (or the high release surface layer) is 0.04 to 0.8 μm, preferably 0.1 to 0.3 μm, and the optical clear adhesive would have optimal peelability performance. When the coating thickness after hardening is less than 0.01 μm, the peeling performance tends to be lowered. Moreover, when the coating thickness after hardening exceeds 0.8 μm, the hardening of the coating film tends to be insufficient, and the peeling performance changes by UV light irradiation.

When the thickness ratio of the high release film 20 to the light release film 40 is 0.5 to 5, the appearance of the OCA optical sheet 30 after peeling is better, and when the preferred thickness ratio is 0.9 to 3.0, the appearance of the OCA optical sheet 30 after peeling is optimal.

The high release film 20 and the light release film 40 of the present disclosure both have flat surfaces and are easily peeled off from the peeled OCA optical sheet 30, reducing the fragmentation of the local OCA optical sheet 30. In particular, the present disclosure uses a thermosetting silicone resin and adds a UV absorber, and the surface is flat and does not cause protrusions during the coating process, and the purpose of uniform peelability can be achieved.

The related art uses an optically clear adhesive to manufacture an OCA optical sheet having a thickness of more than 100 μm. In the production process of the optically clear adhesive, since the thickness is larger, when the outer surface of the optical clear adhesive is dry, the lower layer of the optical clear adhesive is still not dried completely, so that the peeling process is poor in the mature process or the weathering test. In addition, in order to increase the thickness of the OCA optical sheet, the related art also adopts UV light hardening after optical clear adhesive coating and printing, but the disadvantage is that if the film substrate (release layer with PET film) is peeled off, conditions of UV light resistance must be satisfied. A peeling force between the OCA optical sheet and the release layer is affected due to the irradiation of UV light. When UV light is used, peeling off the release film may cause tearing, thus resulting in problems with OCA optical sheet breakage or haze increase.

The high release film 20 of the present disclosure includes the PET film 21, and the light release film 40 of the present disclosure includes the PET film 41, and a single-sided or double-sided surface of the PET film 21 or 41 has a special coating release agent, based on the total weight of the release agent, the composition of the release agent includes: (hereinafter all are wt %)

a. Thermosetting silicone resin: 0.5 to 7 wt %;

b. Platinum catalyst 0.05 to 0.3 wt %;

c. Solvent containing methyl ethyl ketone (MEK)/toluene/xylene (weight ratio=50/40/10) 92.2 to 99.4 wt %; and

d. UV absorber 0.05 to 0.5 wt %;

The UV absorber is added to the composition of the release agent, and is applied to one side or both sides of a continuous-packaged polyester PET film, dried and hardened by an oven, and then wound into a roll-like release film.

The release film of the present disclosure has a heat curing temperature of 50 to 180° C., preferably 80 to 130° C., heat treatment for 5 seconds or more, preferably heat treatment for 10 seconds or more, thereby forming a hardened film, which does not cause wrinkle deformation due to excessive temperature, and does not become hard and brittle that affect texture. Moreover, the polymer film of the produced release film is stable in properties, and the release force is stable and does not change with time.

The method for manufacturing the release film of the present disclosure includes the following steps:

1. Based on the total weight of the release agent, preparing the release agent in the following steps:
a. taking 0.5 to 7 wt % of thermosetting silicone resin;
b. adding 92.2 to 99.4 wt % of the solvent to stir evenly; the solvent is preferably a mixture of methyl ethyl ketone (MEK)/toluene/xylene (weight ratio=50/40/10);
c. further adding 0.05 to 0.3 wt % of platinum catalyst and stirring for 15 minutes; and
d. adding another 0.05 to 0.5 wt % of UV absorber and stirring for 15 minutes;

2. coating the release agent on one side or both sides of a polyester film on the continuously running coating machine; and

3. after coating the release agent, heating the polyester film at a temperature of 80 to 130° C. for 10 to 30 seconds, and then drying and hardening the heated polyester film to obtain a release film.

In the release agent formulated according to the present disclosure, the thermosetting silicone resin may be selected from an acrylic graft silicone resin, an epoxy graft silicone resin, or polydimethylsiloxane resin, preferably the polydimethylsiloxane resin which has better release property and heat resistance.

The polydimethylsiloxane resin includes various structures, including polydimethylsiloxane resin with terminal ends grafted with vinyl, polydimethylsiloxane resin with terminal end and middle end grafted with vinyl, polydimethylsiloxane resin with terminal ends grafted with hexenyl, or polydimethylsiloxane resin with terminal end and middle end grafted with hexenyl, preferably polydimethylsiloxane resin with terminal end and middle end grafted with hexenyl.

Sources of commercially available polydimethylsiloxane resins, include: Shin-Etsu Chemical Co.'s KS-774, KS-778, KS-847T, KS-3705 or X-62-2112; Dow Corning's 362, 7367, LTC-885, or LTC-750A; Wacker Chemie AG's D944 or D955; or Toshiba's 6700N.

In the release agent to be formulated according to the present disclosure, a peeling control agent may be additionally added to impart a film peeling property to the cured silicone resin coating layer.

In the release agent formulated by the present disclosure, the main function of the platinum catalyst is to promote the degree of participation of the silicone resin in the hardening reaction. Good hardening reaction can promote the curing and film formation of the silicone resin, while in bad hardening reaction the silicone resin cannot be cured and the film cannot be formed.

Thus, the release agent formulated by the present disclosure is a reactive release agent rather than a hybrid release agent.

Sources of commercially available platinum catalyst include: Dow Corning's DC-4000, or at least one of Shin-Etsu Chemical Co.'s PL-50T.

In the release agent formulated by the present disclosure, the main function of the UV absorber is to absorb UV light. The UV absorber is added in an amount of from 0.01 to 3 wt %, preferably from 0.03 to 2 wt %, particularly preferably from 0.05 to 0.5 wt %. If the addition amount of the UV absorber is more than 3 wt %, the haze of the OCA optical clear adhesive may be affected, and if the addition amount is less than 0.01 wt %, the peeling property of the release film may be affected.

The UV absorber is selected from 2-hydroxy-4-methoxybenzophenone (abbreviated as UV absorber P) or 2,4-dihydroxybenzophenone (abbreviated as UV absorber Q).

The release agent formulated by the present disclosure, after heat hardening, the thermosetting silicone resin in its composition will produce a slippery surface. Therefore, the UV type OCA optical clear adhesive 10 of the present disclosure has excellent peeling characteristics after UV curing. Based on the total weight of the release agent, if the thermosetting silicone resin of the release agent is more than 7 wt %, there is a disadvantage that the peeling layer is peeled off and the surface roughness is high, and the surface of the polyester film cannot be completely filled, if less than 0.5 wt %, optical clear adhesive with good peelability cannot be provided.

The present disclosure is further illustrated by the following embodiments and comparative examples, but the present disclosure is not limited thereto.

Properties of each of the release films are measured by the following methods.

1. Release Force Test

The light release film/OCA optical sheet/high release film is cut into a size of 25 mm*20 cm, and the peeling force is tested using a universal testing machine (Cometech Testing Machines Co. Ltd., QC508PA). The machine has a speed of 300 mm/min and is peeled off in a direction perpendicular to the ground. The peeling angle is 180°.

2. Haze Analysis (%)

After bonding the OCA optical sheet to the glass, the high release film is peeled off, and the haze is calculated by using the NDH7000 haze meter manufactured by NIPPON Co., Ltd., using the diffused light and the transmitted light.

3. Appearance Flatness of OCA Adhesive Bonding Glass

After attaching the OCA optical sheet to the glass, and then peeling off the high release film, the appearance flatness of the OCA optical sheet is visually observed with the naked eye, and evaluated by the following criteria:

◯: The OCA optical sheet has good flatness

Δ: The OCA optical sheet is slightly uneven and the glue is not fully recovered.

x: The OCA optical sheet is not flat and is torn.

Preparation of Release Agent a Coated on the Light Release Surface Layer 42

Take polydimethylsiloxane (X-62-2112 resin of Shin-Etsu Chemical Co.) 320 g (5.96 wt %), add methyl ethyl ketone (MEK)/toluene/xylene (weight ratio=50/40/10) solvent 5038.6 g (93.83 wt %), stir well, add platinum catalyst (CAT PL-50T of Shin-Etsu Chemical Co.) 6.4 g (0.12 wt %), stir for 15 minutes, measure and take UV absorber P (2-hydroxy-4-methoxybenzophenone) 5 g (0.09 wt %), stir for 15 minutes, and obtain a silicone resin solution having a solid concentration of the silicone agent of 2.0%.

[Dispatch Release Agent B of High Release Surface Layer]

Take polydimethylsiloxane (KS-847T resin of Shin-Etsu Chemical Co.) 320 g (5.18 wt %), add methyl ethyl ketone (MEK)/toluene/xylene (weight ratio=50/40/10) solvent 5038.6 g (94.38 wt %), stir well, add platinum catalyst (CAT PL-50T of Shin-Etsu Chemical Co.) 6.4 g (0.10 wt %), stir for 15 minutes, measure and take UV absorber P (2-hydroxy-4-methoxybenzophenone) 5 g (0.08 wt %) and peeling control agent KS-8300 (manufactured by Shin-Etsu Chemical Co., Ltd.) 16 g (0.26 wt %), stir for 15 minutes, and obtain a silicone resin solution having a solid concentration of the silicone agent of 2.0%.

### First Embodiment

[Manufacturing a Light Release Film]

The prepared release agent A is applied to a light release PET film having a thickness of 50 μm in a wet coating amount of 12 g/m² by a bar coater. After drying and hardening reaction at a heating temperature of 130° C. for 30 seconds, the light release film is obtained, and then wound into a roll.

[Manufacturing a High Release Film]

The prepared release agent B is applied to a high release PET film having a thickness of 75 μm in a wet coating amount of 12 g/m² by a bar coater. After drying and hardening reaction at a heating temperature of 130° C. for 30 seconds, the high release film is obtained, and then wound into a roll.

A 125 μm OCA optical sheet and a UV type OCA optical clear adhesive made by the light release film and the high release film are taken. The physical properties of the light release film and the high release film are tested, and the results are shown in Table 1.

### Second Embodiment

The formulation and the preparation method are the same as in the first embodiment, except that the amount of the UV absorber of the release agent A for preparing the light release film is increased by 2 wt %. The physical properties of the light release film and the high release film are tested, and the results are shown in Table 1.

### Third Embodiment

The formulation and the preparation method are the same as in the first embodiment, except that the UV absorber P (2-hydroxy-4-methoxybenzophenone) of the release agent A for preparing the light release film is changed to a UV absorber Q (2,4-dihydroxybenzophenone) in an amount of 0.05 wt %. The physical properties of the light release film and the high release film are tested, and the results are shown in Table 1.

### Fourth Embodiment

The formulation and the preparation method are the same as in the third embodiment, except that the amount of the UV absorber of the release agent A for preparing the light release film is increased by 1.5 wt %. The physical properties of the light release film and the high release film are tested, and the results are shown in Table 1.

### Comparative Example 1

The formulation and the preparation method are the same as in the first embodiment, except that the amount of the UV absorber of the release agent A for preparing the light release film is increased by 3.5 wt %. The physical properties of the light release film and the high release film are tested, and the results are shown in Table 1.

### Comparative Example 2

The formulation and the preparation method are the same as in the first embodiment, except that the release agent A for preparing the light release film and the release agent B for preparing the high release film do not use the UV absorber. The physical properties of the light release film and the high release film are tested, and the results are shown in Table 1.

In the related art, the thickness of the OCA optical clear adhesive is required to be more than 100 μm, and the conventionally used thermal clear adhesive is insufficient. Moreover, after UV light irradiation, the peeling force between the optical sheet and the conventional light release film and the high release film increases, resulting in peeling failure or an increase in peeling force that causes a tearing phenomenon. In contrast, in the UV type OCA optical clear adhesive of the present disclosure, the composition of the light release film and the high release film is added with a UV absorber, which can effectively improve the above-mentioned phenomenon.

UV absorber is a kind of light stabilizer, which can absorb the ultraviolet light of the light source and the UV absorber itself would not be changed. In the production process of UV optical clear adhesive, excessive UV light can be absorbed, so that the optical clear adhesive can be hardened, and the excess UV light source does not affect the peeling effect of the release layer, and the purpose of peeling without tearing can be achieved.

The UV absorber selected from 2-hydroxy-4-methoxybenzophenone or 2,4-dihydroxybenzophenone is added to the composition of the UV type OCA optical clear adhesive of the present disclosure so as to achieve an appropriate peeling force between an optical sheet and the light release film and the high release film, so that tearing would not occur.

TABLE 1

| | | | | | Comparative | |
|---|---|---|---|---|---|---|
| | Embodiment | | | | example | |
| | 1 | 2 | 3 | 4 | 1 | 2 |
| Light release | 50 | 50 | 50 | 50 | 38 | 38 |
| PET film | | | | | | |
| thickness (μm) | | | | | | |
| UV absorber | P | P | Q | Q | P | — |
| UV absorber | 0.09 | 2 | 0.05 | 1.5 | 3.5 | 0 |
| addition | | | | | | |
| amount (wt %) | | | | | | |
| OCA | 125 | 125 | 125 | 125 | 50 | 50 |
| thickness (μm) | | | | | | |
| High release | 75 | 75 | 75 | 75 | 50 | 50 |
| PET film | | | | | | |
| thickness (μm) | | | | | | |
| UV absorber | P | P | Q | Q | P | — |
| UV absorber | 0.08 | 2 | 0.05 | 1.5 | 3.5 | 0 |
| addition | | | | | | |
| amount (wt %) | | | | | | |
| Peeling force | 10 | 14.1 | 12.2 | 15 | 16.3 | 82 |
| of light | | | | | | |
| release film | | | | | | |
| Peeling force | 25 | 50.4 | 45.9 | 58.5 | 65 | 462 |
| of high | | | | | | |
| release film | | | | | | |
| Peeling force | 2.5 | 3.6 | 3.8 | 3.9 | 4 | 5.6 |
| of high | | | | | | |
| release film/ | | | | | | |
| Peeling force | | | | | | |
| of light | | | | | | |
| release film | | | | | | |
| Haze of | 0.6 | 0.79 | 0.74 | 1.2 | 2.3 | 3.6 |
| OCA (%) | | | | | | |
| Flatness of | ∘ | ∘ | ∘ | ∘ | Δ | x |
| OCA optical | | | | | | |
| sheet | | | | | | |

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An optical clear adhesive (OCA) including an OCA transparent film, characterized in that:
a lower surface of the OCA transparent film is coated with a high release film and an upper surface is coated with a light release film, wherein the high release film and the light release film contain 0.01-3 wt % of UV absorber.

2. The optical clear adhesive according to claim 1, wherein each of structures of the high release film and the light release film includes a substrate, and one or both sides of the substrate are coated with a release agent including the following components:
a. 0.5-7 wt % of thermosetting silicone resin;
b. 0.05-0.3 wt % of platinum catalyst;
c. 92.2-99.4 wt % of a solvent including butanone, toluene and xylene in a weight ratio of 50:40:10; and
d. 0.05-0.5 wt % of UV absorber.

3. The optical clear adhesive according to claim 1, wherein the UV absorber is selected from 2-hydroxy-4-methoxybenzophenone or 2,4-dihydroxybenzophenone.

4. The optical clear adhesive according to claim 2, wherein the UV absorber is selected from 2-hydroxy-4-methoxybenzophenone or 2,4-dihydroxybenzophenone.

5. The optical clear adhesive according to claim 1, wherein the high release film has a thickness of 50 to 150 μm, and a thickness ratio of the high release film to the light release film is 0.5 to 5.

6. The optical clear adhesive according to claim 2, wherein the high release film has a thickness of 50 to 150 μm, and a thickness ratio of the high release film to the light release film is 0.5 to 5.

7. The optical clear adhesive according to claim 1, wherein the high release film is selected from a PET release film having a release force of 10 to 90 g/2.5 cm, and a ratio of the release force of the high release film to the light release film is 2.5 to 3.5.

8. The optical clear adhesive according to claim 2, wherein the high release film is selected from a PET release film having a release force of 10 to 90 g/2.5 cm, and a ratio of the release force of the high release film to the light release film is 2.5 to 3.5.

9. The optical clear adhesive according to claim 2, wherein the thermosetting silicone resin is selected from acrylic grafted silicone resin, epoxy grafted silicone resin, or polydimethylsiloxane resin.

10. The optical clear adhesive according to claim 9, wherein the polydimethylsiloxane resin is selected from polydimethylsiloxane resin with terminal ends grafted with vinyl, polydimethylsiloxane resin with terminal end and middle end grafted with vinyl, polydimethylsiloxane resin with terminal ends grafted with hexenyl, or polydimethylsiloxane resin with terminal end and middle end grafted with hexenyl.

11. An optical clear adhesive manufacturing method, comprising following steps:
1) preparing a release agent based on a total weight of the release agent;
a. 0.5 to 7 wt % of thermosetting silicone resin is taken;
b. 92.2 to 99.4 wt % solvent is added and stirred evenly;
c. 0.05 to 0.3 wt % of platinum catalyst is further added and stirred for 15 minutes; and
d. 0.05 to 0.5 wt % of UV absorber is added and stirred for 15 minutes to obtain the release agent; wherein the UV absorber is selected from 2-hydroxy-4-methoxybenzophenone or 2,4-dihydroxybenzophenone;
2) coating the release agent on one side or both sides of a polyester film on a continuously running coating machine, and the release agent having a coating thickness of 1 to 25 μm; and
3) after coating the release agent, heating the polyester film at a temperature of 80 to 130° C. for 10 to 30 seconds, and then drying and hardening the heated polyester film to obtain a release film.

12. The optical clear adhesive manufacturing method according to claim 11, wherein the thermosetting silicone resin is selected from acrylic grafted silicone resin, epoxy grafted silicone resin, or polydimethylsiloxane resin.

13. The optical clear adhesive manufacturing method according to claim 11, wherein the solvent used for formulating the release agent includes methyl ethyl ketone, toluene and xylene in a weight ratio of 50:40:10.
